(19) United States
(12) Patent Application Publication
(10) Pub. No.: US 2023/0078947 A1
(43) Pub. Date: Mar. 16, 2023

(54) Liquid Complex Fertilizer and Methods of Making the Same

(71) Applicants: Michael Troy Owsley, Quincy, IL (US); Kevin Timothy Swim, Toronto (CA)

(72) Inventors: Michael Troy Owsley, Quincy, IL (US); Kevin Timothy Swim, Toronto (CA)

(21) Appl. No.: 17/899,303

(22) Filed: Aug. 30, 2022

Related U.S. Application Data
(60) Provisional application No. 63/238,718, filed on Aug. 30, 2021.

(51) Int. Cl. C05F 1/00

(52) U.S. Cl. CPC C05F 1/002

(57) ABSTRACT

A liquid complex fertilizer or soil amendment composition is provided, made by steps of alkaline hydrolysis of fish under aqueous conditions and conditions of temperature and agitation suitable to provide a liquid fish hydrolysate comprising one or more humic substances. Methods for producing the liquid complex fertilizer are described.

### RELATED APPLICATIONS

This application is a utility patent application claiming the benefit of U.S. Provisional Application Ser. No. 63/238,718, filed Aug. 30, 2021, the entire disclosure of which is incorporated herein by reference.

### TECHNICAL FIELD

The present invention relates to the field of fertilizers, and in particular liquid fertilizers. Embodiments of the present invention relate to a liquid fertilizer comprised of processed invasive aquatic species.

### BACKGROUND

Fertilizers are classified in several ways. They are classified according to whether they provide a single nutrient (e.g., K, P, or N), in which case they are classified as “straight fertilizers.” “Complex fertilizers” or multi-nutrient fertilizers provide two or more nutrients, for example N and P.

Humic substances are organic compounds that are important components of humus, the major organic fraction of soil, peat, coal, and others. Humic substances or humic mater in isolation is the result of a chemical extraction from soil organic matter or dissolved organic matter, and represent humic molecules distributed in soil or water. Humic substance may be viewed as heterogeneous and relatively small molecular components of soil organic matter auto-assembled in supramolecular associations and composed of a variety of compounds of biological origin and synthesized by abiotic and biotic reactions in soil. It is the large molecular complexity of the soil humeone that confers to humic matter its bioactivity in soil and its role as plant growth promoter.

Humic substances may be divided into three main fractions: humic acids, fulvic acids, and humin. Humic and fulvic acids may be extracted as a colloidal sol from solid phase sources. Humic acid is a complex mixture of different acids containing carboxyl and phenolate groups whose mixture behaves as a dibasic acid or a tribasic acid. Fulvic acids are poly-electrolytes and are unique colloids that diffuse easily through membranes.

Traditional methods of producing humic substances include composting lignin or adding biochar, industrial synthesis of artificial humic substances from organic feedstocks, hydrolysis and oxidation of lignosulfonate to mimic humus, hydrothermal conversion of agricultural litter to an artificial humic substance, and oxidation of lignite (brown coal).

Various processes are known for forming humic acid from coal, leonardite or other terrestrial sources. The traditional way of extracting humic acids from oxidized coal is by alkaline hydrolysis, in which a slurry of equal amounts of lye and the oxidized coal is mixed with water to give a concentration of 5-10% (m/v). For example, 20 grams of oxidized coal and 50 grams of sodium hydroxide are slurried in 300 ml of water. The slurry is mixed for 5 hours after which residue is removed and an acid is added to precipitate the humic acid.

One example of a humic acid water-soluble fertilizer is disclosed in CN 109180337. There, the preparation of humic acid water-soluble fertilizer, and in particular to a kind of method that pyrohydrolysis organic waste prepares humic acid water-soluble fertilizer is disclosed.

Additionally, KR 101762243 discloses a method for producing an organic/inorganic mixed liquid fertilizer from an aqueous humectant-derived liquid fertilizer from a fish meal processing by-product derived from squid and fish by-product.

DE 2020/19104210U1 discloses biological compounds of natural humic acids/fulvic acids with proteins for use as feed additives or dietary supplements. Embodiments include (a) at least one humic acid and/or at least one fulvic acid; (b) at least one vegetable protein or animal protein; and (c) water, characterized in that the humic acid and/or the fulvic acid have a proportion of 30 to 70% and that at least one vegetable protein or an animal protein have a proportion of 30 to 70% in each case with respect to the dry matter of the biological compound.

Invasive carp comprise a unique family of fish in that they consume large amounts of algae and plant material per day which is present in the gut of the fish in various states of digestion. Examples of fish species referred to as “invasive carp” include without intending any limitation the following: Cyprinus carpio (Common Carp), Hypophthalmichthys molitrix (Silver Carp), Hypophthalmichthys nobilis (Bighead Carp), Mylopharyngodon piceus (Black Carp), and Ctenopharyngodon idella (Grass Carp). Collectively these fish are referred to as “Asian carp” or “Copi.”

Humic compounds/humic substances are known to be present in the fish blood and bone. The present inventors have discovered that beneficial humic substances such as humic acid can be formed from these and other fish materials and extracted by alkaline hydrolysis. The invasive carp species feed on the excess algae in the waterways that is created by fertilizer run-off from farms, essentially cleaning the river. Per Federal law only an invasive species can be manufactured into fertilizer directly (as whole fish), for other fish species the fish must be primarily used as food with only the trimmings and scraps available for fertilizer production. The common practice of eviscerating fish to produce food products exposes the gut contents and blood, which as noted are suitable sources for humic substances, to oxygen, microbial contamination and heat which affect the humic substance integrity. By using the entire fish all the humic substance-bearing elements of the fish are available for extraction and are kept in their natural form.

Thus, one advantage of the present invention is that it involves a process of using the invasive carp as a conveyor (by way of its diet) to produce an eco-friendly fertilizer comprising humic substances. The agricultural runoff from industrial farming feeds algae in the river, which are eaten by the fish (cleaning the river of excess nutrients), and then the fish are transformed into fertilizer which is applied back to the land.

### SUMMARY

One embodiment of the present disclosure is a liquid complex fertilizer containing humic substances made by processing invasive fish species. In an embodiment, the processing comprises alkaline hydrolysis.

In an embodiment, a liquid complex fertilizer comprising humic substances is produced by processing invasive carp fish species in a quantity of water and sodium, calcium, magnesium, and/or potassium hydroxides to form a liquid product. The process of the present invention produces a liquid product free of solids or with a low level of solids. This results in a product unlikely to clog application equipment and which can be used at full strength.

In another embodiment of the present invention, the fish can be refrigerated prior to alkaline hydrolysis. The resulting product desirably has improved odor characteristics.

In another embodiment, the whole fish is processed rather than only trimmings and scraps remaining after breaking the fish down for food. Without intending to be bound by any particular theory or mechanism, the present inventors have discovered that by using the whole fish without separating fat prior to extraction as is done in other processes results in fat saponification during the alkaline hydrolysis process, producing surfactants. These surfactants may desirably help to extract humic acid. The present inventors have also surprisingly found that a pH range suitable for effectively processing the whole fish is also effective for holding humic substances such as humic acid in solution.

One advantage of the present invention is the discovery that this invasive fish can be used as a source of humic substances for soil amendment, soil remediation, plant fertilization, etc., reducing the necessity of using mined minerals and heavy metals.

Without being bound by theory or mechanism, the hydroxides used in embodiment of the invention provide additional nutrients, and the process extracts organic nitrogen (primarily from the fish flesh) and phosphorus, calcium and magnesium (primarily from the fish bone) from the fish. The result is a complex fertilizer containing basic plant nutrients as well as high levels of humic acid (average>9%) and fulvic acid, and low levels (approximately 0.1%) of sodium (if sodium containing processing chemicals are avoided).

In one embodiment of the present disclosure the entire fish is processed in a tissue digestion device. One example is a Bio-Liquidator™ device, a tissue digestion device manufactured by Bio-Response Solutions. Embodiments are described in U.S. Pat. Nos. 9,018,433; 9,233,405; and 9,492,697. These devices, in general, relate to an apparatus to provide low-temperature alkaline hydrolysis tissue digestion methods and apparatuses. The Bio-Liquidator patents described above disclose a method for digesting tissue comprising providing a tissue digester, the tissue digester including a fluid vessel.

### BRIEF DESCRIPTION OF THE DRAWINGS

The presently-disclosed subject matter will be better understood, and features, aspects and advantages other than those set forth above will become apparent when consideration is given to the following detailed description thereof. Such detailed description makes reference to the following drawings, wherein:

FIG. 1 illustrates a representative embodiment of the process of the present disclosure.

While the disclosure is susceptible to various modifications and alternative forms, specific embodiments thereof have been shown by way of example in the drawings and are herein described below in detail. It should be understood, however, that the description of specific embodiments is not intended to limit the disclosure to cover all modifications, equivalents and alternatives falling within the spirit and scope of the disclosure as defined by the appended claims.

### DETAILED DESCRIPTION

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

While the terms used herein are believed to be well understood by those of ordinary skill in the art, certain definitions are set forth to facilitate explanation of the presently-disclosed subject matter.

Unless defined otherwise, all technical and scientific terms used herein have the same meaning as is commonly understood by one of skill in the art to which the invention(s) belong.

Any patents, patent applications, published applications and publications, GenBank sequences, databases, websites and other published materials referred to throughout the entire disclosure herein, unless noted otherwise, are incorporated by reference in their entirety.

Where reference is made to a URL or other such identifier or address, it understood that such identifiers can change and particular information on the internet can come and go, but equivalent information can be found by searching the internet. Reference thereto evidences the availability and public dissemination of such information.

Although any methods, devices, and materials similar or equivalent to those described herein can be used in the practice or testing of the presently-disclosed subject matter, representative methods, devices, and materials are described herein. No limitation to such representative methods, devices, or materials is intended or should be inferred.

Following long-standing patent law convention, the terms “a”, “an”, and “the” refer to “one or more” when used in this application, including the claims, unless the context clearly dictates otherwise. Thus, for example, reference to “a polypeptide” includes one or more of such polypeptides, and so forth.

Unless otherwise indicated, all numbers expressing quantities of ingredients, properties such as reaction conditions, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, ElZ specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

As used herein, the terms “effective amount” and “amount effective” refer to an amount that is sufficient to achieve the desired result or to have an effect on an undesired condition.

### DETAILED DESCRIPTION

### Example 1

Turning again to the present disclosure, process for forming humic substances from invasive carp fish species is disclosed. Inputs to the process include invasive fish species, alkaline hydroxides, water, and stabilizing/neutralizing acids. Outputs of the process include liquid fish hydrolysate, alkali salts of fish bone/tissue, undissolved fish bone/tissue solids, soaps, alkali salts of neutralizing acids, humic substance degradation components, organic nitrogen, organic carbon, phosphorus compounds, and ammonia. Beneficial components of the end products which provide beneficial uses in fertilizers, soil amendments, and the like include nitrogen (organic nitrogen and ammonia), phosphorus, potassium, humic acid, fulvic acid, and organic carbon.

The presently disclosed process comprises at a high level the following steps:
(i) Invasive fish species (raw material) stored in coolers at reduced temperature;
(ii) A processing vessel is filled with a desired quantity of fish;
(iii) Alkaline hydrolysis agent is added to the processing vessel on top of the fish;
(iv) Water is added to the vessel;
(v) Contents of the vessel are heated and agitated;
(iv) the finished liquid fish product is discharged into storage tanks and is stabilized with neutralizing acid to achieve a desired pH.

In embodiments, invasive carp species or portions thereof are combined with water and alkali including without intending any limitation sodium, calcium, magnesium and/or potassium hydroxides to form a mixture, heating, and agitating the mixture until the liquification of the fish is completed (5-24 hours). The mixture can be made in any type of vessel and the heat and agitation can be provided by any suitable means, it not being necessary to provide special equipment for this purpose. However, preferably the equipment should be adaptable to slow and complete agitation and control of heat near the boiling point of water. The mixture also can be prepared in smaller or larger batches than indicated in the example here.

### Example 2

In an embodiment, the disclosed process comprises:
(i) Invasive carp species (raw material) stored in coolers (from about 32° F. to about 35° F.);
(ii) A processing vessel (Bio-liquidator™) is charged with approximately 3500 pounds of fish;
(iii) 330.7 pounds of Potassium Hydroxide is added to the processing vessel on top of the fish;
(iv) Water (approximately 800 gallons or 6676 pounds) is added to the vessel;
(v) Contents of the vessel are heated to approximately 190° F. with continuous agitation (from about 5 to about 24 hours); and
(iv) the finished liquid product is discharged into storage tanks and is stabilized with phosphoric or sulfuric acid to achieve a pH no lower than about 3.5, typically between about 7 and about 10.5.

### Example 3

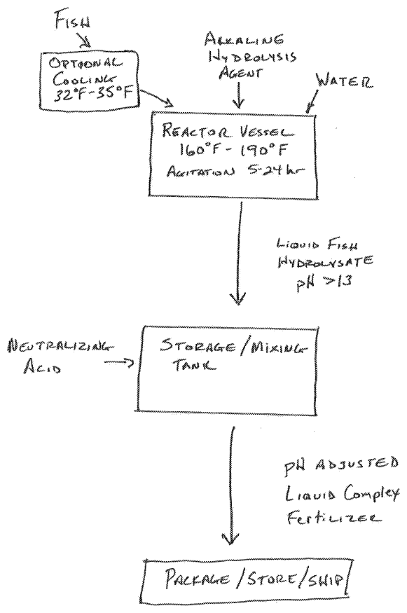

Another embodiment (see FIG. 1) of the process of the invention comprises the following steps:
1) Invasive carp species (raw material) stored in coolers at approx. 32-35° F.;
2) Vessel is filled with approximately 100 parts of invasive carp;
3) Range of 6-20 parts of sodium, calcium, magnesium, and/or potassium hydroxides is added to the vessel on top of the fish;
4) Approximately 200 parts of water is added to the vessel;
5) Contents of vessel heated to a minimum of 160° F. and a maximum of 190° F. and continuously, fully and slowly agitated. After 5-24 hours the process is completed.
6) Finished Liquid Fish product is discharged from the vessel into storage tanks and is stabilized/neutralized typically with phosphoric or sulfuric Acid to a pH of no lower than about 3.5, typically between about 7 and about 10.5.

In an embodiment, 10 parts of Potassium Hydroxide is used and the vessel contents are heated to 190° F. with a process run time of 16 hours. Alternative stabilizing/neutralizing acids are contemplated for step 6), including without intending any limitation citric acid, formic acid, acetic acid, nitric acid or carbonic acid (by injecting carbon dioxide gas). Prior to neutralization the liquification/hydrolysis product discharges from the vessel at a pH of approximately 13, and is adjusted to a pH of from about 9.0 to 10.5 to discourage humic acid precipitation and microbial growth.

One of ordinary skill in the art will readily understand that the above-disclosed processes can be scaled up to a larger volume or scaled down to a smaller volume of production; and temperatures, chemical and run time can be adjusted and still produce the product.

### Example 4

Table 2 illustrates nutrient and other profiles of various stages of a liquid complex fertilizer according to the present disclosure. “HOT” references the liquid fish hydrolysate after hydrolysis and prior to any step of pH adjustment, i.e. pH 11.5-13 or higher. “Mixed” refers to the mixed product immediately prior to taking a sample. “Middle” refers to a middle completely liquid layer of the liquid complex fertilizer after tank settling, and comprises 90% or more of the product. “Top” refers to the top layer of the liquid complex fertilizer after tank settling, primarily the saponified fish fat, and comprises less than 5% of the product. As can be seen from the data, the liquid complex fertilizer comprises a significant component of humic acid and total carbon.

TABLE 2
Nutrition profiles of liquid complex fertilizer

| | | Reel Big | LR220049- | LR220049- | LR220049- |
|---|---|---|---|---|---|
| Sample ID | Q2 | Bloom | 01 | 02 | 03 |
| pH | 10.5 | 10.5 | HOT | 9.2 | HOT |
| layer | Mixed | Mixed | Middle/ | Middle/ | Top |
| NUTRITION | | | Mixed | Mixed | |
| PROFILE: | | | | | |
| Nitrogen | | 1.28 | 0.98 | 0.87 | <0.01 |
| (total), % | | | | | |
| Nitrate- | | <0.01 | | | |
| nitrogen, % | | | | | |
| Ammonium | | 0.114 | | | |
| nitrogen | | | | | |
| (total), % | | | | | |
| Urea nitrogen | | | | | |
| (N), % | | | | | |
| Total Kjeldahl | | 1.15 | | | |
| nitrogen | | | | | |
| (TKN), % | | | | | |
| Water insoluble | | 0.03 | | | |
| nitrogen | | | | | |
| (WIN), % | | | | | |
| Water soluble | | 1.12 | | | |
| nitrogen, % | | | | | |
| Phosphate | | 0.78 | 0.15 | 1.98 | 0.58 |
| (P2O5), % | | | | | |
| Phosphate | | | | | |
| (available | | | | | |
| P2O5) | | | | | |
| Phosphorus | | 0.34 | | | |
| (total), % | | | | | |
| Potash (K2O), | | 4.25 | 3.16 | 3.18 | 0.85 |
| % | | | | | |
| Potassium | | | | | |
| (soluble, as | | | | | |
| K2O/Potash), | | | | | |
| % | | | | | |
| Potassium | | 3.53 | | | |
| (total), % | | | | | |
| HUMATE | | | | | |
| DATA: | | | | | |
| Humic Acid, % | | 9.51 | 53.34 | <0.10 | 54.45 |
| Organic Matter | | | | | |
| (550 oC), % | | | | | |
| Organic Matter | | | | | |
| as Carbon, % | | | | | |
| Fulvic Acid, % | | | 2.02 | 0.99 | 1.19 |
| Carbon (total), | | 8.628 | | | |
| % | | | | | |
| METALS: | | | | | |
| Boron (total), | <100 | <5.00 | | | |
| ppm | | | | | |
| Sulfur (total), | 0.11 | 0.09 | | | |
| % | | | | | |
| Magnesium | 0.05 | 0.07 | | | |
| (total), % | | | | | |
| Sodium (total), | 0.08 | 0.09 | | | |
| % | | | | | |
| Iron (total), | 58.3 | 76.6 | | | |
| ppm | | | | | |
| Calcium (total), | 0.31 | 0.31 | | | |
| % | | | | | |
| Manganese | <20.0 | <20.0 | | | |
| (total), ppm | | | | | |
| Arsenic (total), | <5.0 | <10.0 | | | |
| mg/kg | | | | | |
| Cadmium | <0.50 | <0.5 | | | |
| (total), mg/kg | | | | | |
| Cobalt (total), | <1.00 | <1.00 | | | |
| mg/kg | | | | | |
| Chromium | | <1.00 | | | |
| (total), mg/kg | | | | | |
| Copper (total), | 1.1 | <1.0 | | | |
| mg/kg | | | | | |
| Lead (total), | <5.0 | <5.0 | | | |
| mg/kg | | | | | |
| Mercury (total), | <0.05 | <0.05 | | | |
| mg/kg | | | | | |
| Molybdenum | <1.0 | <1.0 | | | |
| (total), mg/kg | | | | | |
| Nickel (total), | <1.0 | <1.0 | | | |
| mg/kg | | | | | |
| Selenium | <5.0 | <10.0 | | | |
| (total), mg/kg | | | | | |
| Zinc (total), | 5.6 | 2.3 | | | |
| mg/kg | | | | | |
| MICROBIALS: | | | | | |
| Salmonella, | | <0.26 | | | |
| MpN/4 g | | | | | |
| Fecal | | <0.2 | | | |
| coliforms, | | | | | |
| MPN/g | | | | | |
| E. coli | | <3.0 | | | |
| (generic), | | | | | |
| MPN/g | | | | | |
| OTHER | | | | | |
| PROPERTIES: | | | | | |
| Bulk density | | 1.05 | | | |
| (loose) | | | | | |
| Viscosity, cSt | | 2.4 | | | |
| Viscosity, cPs | | | 2600 | | |

Application rates for use as fertilizer for the composition disclosed herein may vary according to intended use. For example, the product may be applied undiluted (about 10 gallons/acre) for seed row starter. For vegetable crops, the product may be applied at a 1:10 dilution rate, 5 gallons/acre. For field crops, the product may be applied at a 1:10 dilution rate, 3 gallons/acre. For hay/pasture/turf, the product may be applied at a 1:20-1:30 dilution rate, 3 gallons per acre. The products may be applied before or during planting, or multiple times per crop season or harvest.

The liquid fertilizer end product produced has a thin water-like consistency (viscosity of approximately 2.4 cSt) compared to conventional fish fertilizers having a viscosity of approximately 2600 cPs. The disclosed product has a humic acid content of approximately 4-50%. This thin consistency (low viscosity) allows use of the product in sprayers and irrigation systems without causing clogging to the spray system (in comparison to other fish fertilizer manufactured by way of enzyme hydrolysis). Consequentially the product can be mixed/diluted to the end-user's exact needs (more concentrated or less concentrated). This added benefit of end product viscosity is another rare added benefit created by the process of alkaline hydrolysis.

Equally, with conventional fish-based fertilizers unpleasant odor is usually an issue. The common products available in the market have a very pungent rotten smell. As noted above, optionally the fish are stored at cool temperatures (approximately 32-35° F.) before processing, and because the alkaline hydrolysis process itself helps deodorize the product, the end result is a more pleasant fresh fish smell making the fertilizer indoor-, outdoor-, and hydroponic-friendly.

Yet another benefit derives from the disclosed process wherein the pH level is kept sufficiently high to prevent humic acid components of the humic substances from precipitating from the liquid phase. This higher pH also may be beneficial to customers compared to other lower pH products, depending on their soil pH or chemical characteristics of other fertilizers or additives they may be using, such as seaweed extracts and/or pesticides.

Furthermore, because invasive fish are used as the humate source instead of mined minerals, heavy metals are much reduced. Table 1 below compares a product derived by the presently disclosed process with several commercially available registered soil amendment products on the market that contain humic substances. The data are derived from Midwest Laboratories (presently disclosed composition) and Oregon Department of Agriculture registry of fertilizers, ag minerals, ag amendments and lime products (commercial products).

TABLE 1

| | | Humic | Arsenic, | Cadmium, | Mercury, | Lead, | Nickel, |
|---|---|---|---|---|---|---|---|
| Registrant/Manufacturer | Product Name | Acid, % | ppm | ppm | ppm | ppm | ppm |
| Wilbur-Ellis Company LLC | 6% Humic Acid | 6 | <0.54 | 0.4 | 0.0092 | 14 | 1.2 |
| | Concentrate Solution | | | | | | |
| Oregons Only | Zeus Juice | 5 | 0.81 | 0.03 | <0.05 | 0.5 | 1.4 |
| | (w/5% Humic Acids) | | | | | | |
| Oregons Only | Zeus Juice | 7 | <10.0 | <5.0 | <0.2 | <5.0 | <5.0 |
| | Growth Enhancer | | | | | | |
| | (w/7% Humic Acids) | | | | | | |
| Modern Ag Products LLC | Humic 4% | 4 | 0.094 | 0.019 | 0.000711 | 0.373 | 0.212 |
| Lignotech USA Inc | BorreGro HA-2 | 12 | 2.7 | <0.1 | 0.3 | <0.6 | 1.8 |
| | (Liquid) Humic Acid | | | | | | |
| Earthgreen Products Inc | Grow-Plex SP | 10 | <5.0 | <0.5 | 0.09 | 10.8 | 7.4 |
| | (w/10% Humic Acid) | | | | | | |
| Earthfort | Soil ReVive | 7 | 2.65 | 0.28 | <0.05 | 0.6 | 0.5 |
| | (w/7% Humic Acid) | | | | | | |
| Brandt Consolidated Inc | Brandt Uptake | 6 | 1.6 | 0.1 | <0.04 | 3.7 | 0.9 |
| | Advanced Humic Acid | | | | | | |
| | (w/6% Humic Acid) | | | | | | |
| Borregaard USA Inc | BorreGro HA-2 | 12 | 2.7 | <0.1 | 0.3 | <0.6 | 1.8 |
| | (Liquid) Humic Acid | | | | | | |
| Bio Plex Organics | Transplant Concentrate | 10 | 0.903 | <0.1 | <0.0595 | 0.604 | <0.2 |
| | and Plant Enhancer Plant | | | | | | |
| | Survival Solutions | | | | | | |
| | (w/10% Humic Acid) | | | | | | |
| Aurora Innovations Inc | Orgonism XL | 10 | 1.78 | 0.52 | 0.08 | 6.0 | 9.3 |
| | (w/10% Humic Acid) | | | | | | |
| Captain Carp | Reel Big Bloom | 9.51 | <0.2 | <0.05 | <0.05 | <0.1 | <1.0 |

Depending on which type of hydroxide chemical used, the alkaline hydrolysis process may provide additional nutrients available from said chemical; and the process extracts organic nitrogen (primarily from the fish flesh) and phosphorus, calcium and magnesium (primarily from the fish bone) from the fish. The result is a complex fertilizer containing basic plant nutrients as well as high levels of humic acid (average>9%) and fulvic acid, and low levels (approximately 0.1%) of sodium (if sodium containing processing chemicals are avoided).

The resulting complex fertilizer may be applied to soil, through irrigation or as a foliar feed either full strength or diluted with water up to a ratio of 2000:1 as necessary. As noted above, the low viscosity of the disclosed product allows use at full strength without concern of clogging or fouling application equipment used for application of soil amendments.

Furthermore, numerous environmental benefits are achieved with this invention, including:

(a) The disclosed liquid fertilizer is a two-in-one product as a source of plant nutrients (nitrogen, phosphorus, potassium, calcium and magnesium) and a source of Humic Acid, resulting in less overall fertilizer use than by using two separate products;

(b) The amount of hydroxide chemical(s) used to process the fish is limited to the amount necessary for extraction;

(c) Compared to other humic acid products that are extracted from coal bed mineral deposits (requiring mining and promoting the extraction of fossil fuels and the carbon emissions that come with them), the presently disclosed process allows for the extraction of humic acid from invasive fish species, providing environmental benefit not only from the end product but also from removal of the source of the product from waterways as well as reduction in mining operations;

(d) The use of invasive carp species for fertilizer production represents a “circle of life”. The agricultural runoff from industrial farming feeds algae in the river, which are eaten by the fish (cleaning the river of excess nutrients), and then the fish are transformed into fertilizer/soil amendment which is applied back to the land; and

(e) Overall, the invention creates a solution in regards to the invasive carp problem and creates a new and useful method to manufacture fertilizer comprising humic substances in an eco-friendly renewable manner compared to the traditional extraction of mineral-derived humates.

The invention thus being described, it will be apparent to those skilled in the art that various modifications and variations can be made in the present invention without departing from the scope or spirit of the invention. Other aspects of the invention will be apparent to those skilled in the art from consideration of the specification and practice of the invention disclosed herein. It is intended that the specification and examples be considered as exemplary only.

All publications, patents, and patent applications mentioned in this specification are herein incorporated by reference to the same extent as if each individual publication, patent, or patent application was specifically and individually indicated to be incorporated by reference.

It will be understood that various details of the presently disclosed subject matter can be changed without departing from the scope of the subject matter disclosed herein. Furthermore, the foregoing description is for the purpose of illustration only, and not for the purpose of limitation. Obvious modifications and variations are possible in light of the above teachings. All such modifications and variations are within the scope of the appended claims when interpreted in accordance with the breadth to which they are fairly, legally and equitably entitled.

What is claimed:

1. A liquid complex fertilizer or soil amendment composition, made by steps of:
alkaline hydrolysis of fish under aqueous conditions and suitable conditions of temperature and agitation to provide a liquefied fish hydrolysate comprising humic substances; and
adjusting a pH of the liquefied fish hydrolysate to a level effective to inhibit precipitation of one or more of the humic substances.

2. The composition of claim 1, wherein the step of alkaline hydrolysis is effected by one or more of sodium hydroxide, calcium hydroxide, magnesium hydroxide, and potassium hydroxide.

3. The composition of claim 2, wherein the step of alkaline hydrolysis is effected by potassium hydroxide.

4. The composition of claim 1, wherein the steps of alkaline hydrolysis and agitation are undertaken at a temperature of from about 160° F. to about 190° F. and a time of from about 5 hours to about 24 hours.

5. The composition of claim 4, wherein the steps of alkaline hydrolysis and agitation are undertaken at a temperature of about 190° F. and for a time of about 16 hours.

6. The composition of claim 4, including a step of adjusting a pH of the liquid fish hydrolysate to no lower than 3.5.

7. The composition of claim 6, wherein the step of adjusting a pH of the liquefied fish hydrolysate is provided by a neutralizing acid and the pH is adjusted to from about 7 to about 10.5.

8. The composition of claim 7, wherein the neutralizing acid is selected from phosphoric acid, sulfuric acid, citric acid, formic acid, acetic acid, nitric acid, carbonic acid, or combinations.

9. The composition of claim 1, wherein the fish is an invasive carp species.

10. The composition of claim 9, wherein the invasive carp species is selected from one or more of Cyprinus carpio (Common Carp), Hypophthalmichthys molitrix (Silver Carp), Hypophthalmichthys nobilis (Bighead Carp), Mylopharyngodon piceus (Black Carp), and Ctenopharyngodon idella (Grass Carp).

11. The composition of claim 1, wherein the step of alkaline hydrolysis is performed on a whole fish.

12. A process for providing a liquid complex fertilizer, comprising:
adding to a suitable vessel a quantity of a fish and a quantity of an alkaline hydrolysis agent;
admixing the quantity of fish and the quantity of alkaline hydrolysis agent under conditions of temperature and agitation time sufficient to provide a liquid fish hydrolysate comprising humic substances; and
adjusting a pH of the liquid fish hydrolysate to a level effective to inhibit precipitation of one or more of the humic substances.

13. The process of claim 12, further comprising selecting the alkaline hydrolysis agent from one or more of sodium hydroxide, calcium hydroxide, magnesium hydroxide, and potassium hydroxide.

14. The process of claim 13, including selecting potassium hydroxide.

15. The process of claim 12, further comprising admixing the quantity of fish and the quantity of alkaline hydrolysis agent at a temperature of from about 160° F. to about 190° F. and a time of from about 5 hours to about 24 hours.

16. The process of claim 15, further comprising admixing the quantity of fish and the quantity of alkaline hydrolysis agent at a temperature of about 190° F. and for a time of about 16 hours.

17. The process of claim 12, further comprising adjusting a pH of the liquid fish hydrolysate to no lower than 3.5 after the steps of admixing the quantity of fish and the quantity of alkaline hydrolysis agent under the conditions of temperature and agitation time.

18. The process of claim 12, further including a step of adjusting a pH of the liquid fish hydrolysate to from about 7 to about 10.5 by a neutralizing acid to inhibit precipitation of the one or more of the humic substances.

19. The process of claim 18, including selecting the neutralizing acid from one or more of phosphoric acid, sulfuric acid, citric acid, formic acid, acetic acid, nitric acid, carbonic acid, or combinations.

20. The process of claim 12, including selecting the quantity of fish from an invasive carp species.

21. The process of claim 20, including selecting the invasive carp species from one or more of Cyprinus carpio (Common Carp), Hypophthalmichthys molitrix (Silver Carp), Hypophthalmichthys nobilis (Bighead Carp), Mylopharyngodon piceus (Black Carp), and Ctenopharyngodon idella (Grass Carp).
